(19) United States
(12) Patent Application Publication
(10) Pub. No.: US 2025/0258492 A1
(43) Pub. Date: Aug. 14, 2025

(54) SYSTEMS AND METHODS FOR PROTOCOL GENERATION FOR LABORATORY EQUIPMENT

(71) Applicant: Veqtor LLC, Rosemont, IL (US)

(72) Inventors: Peter Gordon, Cork (IE); Philip Jarvis, Cork (IE)

(73) Assignee: Veqtor LLC, Rosemont, IL (US)

(21) Appl. No.: 19/047,594

(22) Filed: Feb. 6, 2025

Related U.S. Application Data
(60) Provisional application No. 63/551,186, filed on Feb. 8, 2024.

(51) Int. Cl. G05B 23/02

(52) U.S. Cl. CPC G05B 23/024; G05B 23/0235

(57) ABSTRACT

A system can include one or more memory devices storing instructions thereon that, when executed by one or more processors, cause the one or more processors to receive a prompt to generate a protocol to test a performance of a piece of manufacturing or laboratory equipment, retrieve one or more sets of information associated with the piece of manufacturing or laboratory equipment or an operational condition of the piece of manufacturing or laboratory equipment, input the one or more sets of information into a Machine Learning (ML) model, and generate the protocol to test the performance of the piece of manufacturing or laboratory equipment.

### CROSS-REFERENCE TO RELATED PATENT APPLICATIONS

This application claims the benefit of and priority to U.S. Provisional Patent Application No. 63/551,186, filed on Feb. 8, 2024, the entirety of which is incorporated by reference herein.

### BACKGROUND

Laboratory equipment may perform operations based on specifications of the laboratory equipment. Generation of test protocols for laboratory equipment to help verify their successful operation is a time-consuming and difficult process, and manual definition of such test protocols can result in missed protocols and potentially undiagnosed issues with the laboratory equipment.

### SUMMARY

At least one embodiment relates to a system. The system can include one or more memory devices storing instructions. The instructions can, when executed by one or more processors, cause the one or more processors to receive a prompt to generate a protocol to test a performance of a piece of manufacturing or laboratory equipment. The prompt can include information to identify the piece of manufacturing or laboratory equipment and an operational condition for the piece of manufacturing or laboratory equipment. The instructions can also cause the one or more processors to retrieve, responsive to receipt of the prompt, one or more sets of information associated with the piece of manufacturing or laboratory equipment or the operational condition of the piece of manufacturing or laboratory equipment. The instructions can also cause the one or more processors to input the one or more sets of information into a Machine Learning (ML) model. The ML model can be trained to generate protocols to test performances of a plurality of pieces of manufacturing or laboratory equipment. The instructions can also cause the one or more processors to generate, using the ML model, the protocol to test the performance of the piece of manufacturing or laboratory equipment. The ML model can generate the protocol based on the one or more sets of information.

In some embodiments, the ML model can include a generative pre-trained transformer. The generative pre-trained transformer can generate one or more protocols that were absent from training data used to train the ML model. The one or more protocol can include the protocol to test the performance of the piece of manufacturing or laboratory equipment.

In some embodiments, the instructions can also cause the one or more processors to transmit, responsive to generation of the protocol, one or more signals to cause a user interface to display the protocol. The instructions can also cause the one or more processors to receive, responsive to displaying the protocol, a selection via the user interface to indicate acceptance of the protocol. The instructions can also cause the one or more processors to execute, responsive to receipt of the selection, one or more actions to initiate implementation of the protocol.

In some embodiments, the instructions can also cause the one or more processors to receive, responsive to execution of the protocol, an observed performance of the piece of manufacturing or laboratory equipment. The instructions can also cause the one or more processors to compare the observed performance of the piece of manufacturing or laboratory equipment with the operational condition of the piece of manufacturing or laboratory equipment. The instructions can also cause the one or more processors to determine, responsive to comparing the observed performance of the piece of manufacturing or laboratory equipment with the operational condition of the piece of manufacturing or laboratory equipment, the performance of the piece of manufacturing or laboratory equipment.

In some embodiments, the operational condition of the piece of manufacturing or laboratory equipment can include a plurality of predetermined values and the observed performance of the piece of manufacturing or laboratory equipment can include a plurality of observed values. The instructions can also cause the one or more processors to detect one or more differences between the plurality of predetermined values and the plurality of observed values. The instructions can also cause the one or more processors to retrain the ML model based on the one or more differences.

In some embodiments, training the ML model to generate the protocols to test the performances of the plurality of pieces of manufacturing or laboratory equipment can include obtaining a set of training data including a plurality of predetermined protocols, a plurality of operational conditions for a second plurality of manufacturing or laboratory equipment, and a plurality of observed performances of the second plurality of manufacturing or laboratory equipment based on the plurality of predetermined protocols. Training the ML model to generate the protocols to test the performances of the plurality of pieces of manufacturing or laboratory equipment can also include inputting a first portion of the set of training data into the ML model to train the ML model. Training the ML model to generate the protocols to test the performances of the plurality of pieces of manufacturing or laboratory equipment can also include providing, to the ML model, a second prompt to generate a second protocol to test a performance of a second piece of manufacturing or laboratory equipment. The second prompt can include information to identify the second piece of manufacturing or laboratory equipment and a second operational condition for the second piece of manufacturing or laboratory equipment. Training the ML model to generate the protocols to test the performances of the plurality of pieces of manufacturing or laboratory equipment can also include identifying, responsive to the ML model generating the second protocol, a status of the ML model.

In some embodiments, the first portion of the set of training data can include one or more first predetermined protocols of the plurality of predetermined protocols, one or more first operational conditions of the plurality of operational conditions, and one or more first observed performances of the plurality of observed performances. A second portion of the set of training data can include one or more second predetermined protocols of the plurality of predetermined protocols, one or more second operational conditions of the plurality of operational conditions, and one or more second observed performances of the plurality of observed performances. The one or more second predetermined protocols, the one or more second operational conditions, and the one or more second observed performances can be associated with the second piece of manufacturing or laboratory equipment.

In some embodiments, the one or more sets of information can be retrieved from publicly accessible data sources or internal data sources. The one or more sets of information can include at least one of manufacturing or laboratory equipment specification sheets, manufacturing or laboratory journals, publications, designs documents, requirement documents, drawings, process flow diagrams, sequential flow charts, or control system code.

In some embodiments, the operational condition of the piece of manufacturing or laboratory equipment can include at least one of a runtime for the piece of manufacturing or laboratory equipment, a capacity for the piece of manufacturing or laboratory equipment, a temperature value for the piece of manufacturing or laboratory equipment, a temperature range for the piece of manufacturing or laboratory equipment, a material composition of the piece of manufacturing or laboratory equipment, an agitation speed for the piece of manufacturing or laboratory equipment, a pressure value for the piece of manufacturing or laboratory equipment, a pressure range for the piece of manufacturing or laboratory equipment, a flow value for the piece of manufacturing or laboratory equipment, a flow range for the piece of manufacturing or laboratory equipment, a conductivity value for the piece of manufacturing or laboratory equipment, a moisture value for the piece of manufacturing or laboratory equipment, or a moisture range for the piece of manufacturing or laboratory equipment.

In some embodiments, the instructions can also cause the one or more processors to determine, responsive to retrieval of the one or more sets of information, a format of the one or more sets of information. The instructions can also cause the one or more processors to detect a difference between the format of the one or more sets of information and a predetermined format for the ML model. The instructions can also cause the one or more processors to modify, based on the difference, the one or more sets of information to reflect the predetermined format for the ML model. The instructions can also cause the one or more processors to input, responsive to modification of the one or more sets of information, the one or more sets of information to the ML model.

In some embodiments, the piece of manufacturing or laboratory equipment can be at least one of a single-use bioreactor, a high performance liquid chromatography system, a single-use fermenter, a distributed control system, an aseptic filling machine, a centrifuge, a chromatography skid, an extreme ultraviolet lithography system, an advanced thin-filed deposition tool, or an advanced metrology and defect inspection tool.

At least one embodiment relates to a method. The method can include receiving, by one or more processing circuits, a prompt to generate a protocol to test a performance of a piece of manufacturing or laboratory equipment. The prompt can include information to identify the piece of manufacturing or laboratory equipment and an operational condition for the piece of manufacturing or laboratory equipment. The method can also include retrieving, by the one or more processing circuits, responsive to receipt of the prompt, one or more sets of information associated with the piece of manufacturing or laboratory equipment or the operational condition of the piece of manufacturing or laboratory equipment. The method can also include inputting, by the one or more processing circuits, the one or more sets of information into a Machine Learning (ML) model. The ML model can be trained to generate protocols to test performances of a plurality of pieces of manufacturing or laboratory equipment. The method can also include generating, by the one or more processing circuits, using the ML model, the protocol to test the performance of the piece of manufacturing or laboratory equipment. The ML model can generate the protocol based on the one or more sets of information.

In some embodiments, the ML model can include a generative pre-trained transformer. The generative pre-trained transformer can generate one or more protocols that were absent from training data used to train the ML model. The one or more protocol can include the protocol to test the performance of the piece of manufacturing or laboratory equipment.

In some embodiments, the method can also include transmitting, by the one or more processing circuits, responsive to generation of the protocol, one or more signals to cause a user interface to display the protocol. The method can also include receiving, by the one or more processing circuits, responsive to displaying the protocol, a selection via the user interface to indicate acceptance of the protocol. The method can also include executing, by the one or more processing circuits, responsive to receipt of the selection, one or more actions to initiate implementation of the protocol.

In some embodiments, the method can also include receiving, by the one or more processing circuits, responsive to execution of the protocol, an observed performance of the piece of manufacturing or laboratory equipment. The method can also include comparing, by the one or more processing circuits, the observed performance of the piece of manufacturing or laboratory equipment with the operational condition of the piece of manufacturing or laboratory equipment. The method can also include determining, by the one or more processing circuits, responsive to comparing the observed performance of the piece of manufacturing or laboratory equipment with the operational condition of the piece of manufacturing or laboratory equipment, the performance of the piece of manufacturing or laboratory equipment.

In some embodiments, the operational condition of the piece of manufacturing or laboratory equipment can include a plurality of predetermined values and the observed performance of the piece of manufacturing or laboratory equipment can include a plurality of observed values. The method can also include detecting, by the one or more processing circuits, one or more differences between the plurality of predetermined values and the plurality of observed values. The method can also include retraining, by the one or more processing circuits, the ML model based on the one or more differences.

In some embodiments, training the ML model to generate the protocols to test the performances of the plurality of pieces of manufacturing or laboratory equipment can include obtaining, by the one or more processing circuits, a set of training data including a plurality of predetermined protocols, a plurality of operational conditions for a second plurality of manufacturing or laboratory equipment, and a plurality of observed performances of the second plurality of manufacturing or laboratory equipment based on the plurality of predetermined protocols. Training the ML model to generate the protocols to test the performances of the plurality of pieces of manufacturing or laboratory equipment can also include inputting, by the one or more processing circuits, a first portion of the set of training data into the ML model to train the ML model. Training the ML model to generate the protocols to test the performances of the plurality of pieces of manufacturing or laboratory equipment can also include providing, by the one or more processing circuits, to the ML model, a second prompt to generate a second protocol to test a performance of a second piece of manufacturing or laboratory equipment, the second prompt including information to identify the second piece of manufacturing or laboratory equipment and a second operational condition for the second piece of manufacturing or laboratory equipment. Training the ML model to generate the protocols to test the performances of the plurality of pieces of manufacturing or laboratory equipment can also include identifying, by the one or more processing circuits, responsive to the ML model generating the second protocol, a status of the ML model.

In some embodiments, the operational condition of the piece of manufacturing or laboratory equipment can include at least one of a runtime for the piece of manufacturing or laboratory equipment, a capacity for the piece of manufacturing or laboratory equipment, a temperature value for the piece of manufacturing or laboratory equipment, a temperature range for the piece of manufacturing or laboratory equipment, a material composition of the piece of manufacturing or laboratory equipment, an agitation speed for the piece of manufacturing or laboratory equipment, a pressure value for the piece of manufacturing or laboratory equipment, a pressure range for the piece of manufacturing or laboratory equipment, a flow value for the piece of manufacturing or laboratory equipment, a flow range for the piece of manufacturing or laboratory equipment, a conductivity value for the piece of manufacturing or laboratory equipment, a moisture value for the piece of manufacturing or laboratory equipment, or a moisture range for the piece of manufacturing or laboratory equipment.

In some embodiments, the method can also include determining, by the one or more processing circuits, responsive to retrieval of the one or more sets of information, a format of the one or more sets of information. The method can also include detecting, by the one or more processing circuits, a difference between the format of the one or more sets of information and a predetermined format for the ML model. The method can also include modifying, by the one or more processing circuits, based on the difference, the one or more sets of information to reflect the predetermined format for the ML model. The method can also include inputting, by the one or more processing circuits, responsive to modification of the one or more sets of information, the one or more sets of information to the ML model.

At least one embodiment relates to one or more non-transitory storage media. The one or more non-transitory storage media can store instructions. The instructions can, when executed by one or more processors, cause the one or more processors to perform operations including receiving a prompt to generate a protocol to test a performance of a piece of manufacturing or laboratory equipment. The prompt can include information to identify the piece of manufacturing or laboratory equipment and an operational condition for the piece of manufacturing or laboratory equipment. The instructions can also cause the one or more processors to performing operations including retrieving, responsive to receipt of the prompt, one or more sets of information associated with the piece of manufacturing or laboratory equipment or the operational condition of the piece of manufacturing or laboratory equipment. The instructions can also cause the one or more processors to input the one or more sets of information into a Machine Learning (ML) model. The ML model can include a generative pre- trained transformer configured to generate one or more protocols that were absent from training data used to train the ML model. The instructions can also cause the one or more processors to perform operations including generating, using the ML model including the generative pre- trained transformer, the protocol to test the performance of the piece of manufacturing or laboratory equipment. The ML model including the generative pre-trained transformer can generate the protocol based on the one or more sets of information.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system to generate one or more protocols to test one or more pieces of laboratory equipment, according to some embodiments.

FIG. 2 is a table including operational conditions for one or more pieces of laboratory equipment, according to some embodiments.

FIG. 3 is a table including protocols to test one or more pieces of laboratory equipment, according to some embodiments.

FIG. 4 is a flow chart of a process to train a Machine Learning (ML) model to generate protocols to test one or more pieces of laboratory equipment, according to some embodiments.

FIG. 5 is a flow diagram of a process to generate protocols to test one or more pieces of laboratory equipment, according to some embodiments.

FIG. 6 is a block diagram of a system architecture illustrating communication between systems of the system architecture, according to some embodiments.

FIG. 7A is a flow diagram of a process to generate one or more protocols, according to some embodiments.

FIG. 7B is a continuation of the flow diagram illustrated in FIG. 7A, according to some embodiments.

FIG. 7C is a continuation of the flow diagram illustrated in FIG. 7B, according to some embodiments.

FIG. 8 is an example user interface including information generated by the system illustrated in FIG. 1, according to some embodiments.

FIG. 9 is an example user interface including information generated by the system illustrated in FIG. 1, according to some embodiments.

FIG. 10 is an example user interface including information generated by the system illustrated in FIG. 1, according to some embodiments.

FIG. 11 is an example user interface including information generated by the system illustrated in FIG. 1, according to some embodiments.

### DETAILED DESCRIPTION

Referring generally to the FIGURES, systems and methods for protocol generation for laboratory equipment are described herein. Protocol generation may refer to and/or include generating procedures and/or testing criteria to evaluate performances of laboratory equipment. In the life science manufacturing industry, reaching equipment and/or performance standards may impact whether equipment and/or processes meet standards associated with quality and compliance within the life science manufacturing industry. It should be understood that various embodiments of the present disclosure may be utilized to generate protocols for testing equipment at any stage, including new equipment during or after manufacturing or existing equipment to test ongoing performance of the equipment (e.g., to monitor potential degradation or changes in conditions over time). Further, while the present disclosure discusses protocol generation for laboratory equipment as one possible use case or implementation space, it should be understood that the various features and embodiments described herein are equally applicable to generation of protocols/test cases for various types of equipment other than laboratory equipment, and all such implementations are contemplated within the scope of the present disclosure. As one example, in some implementations, the features and embodiments described herein may be utilized to generate protocols for testing industrial equipment (e.g., sensitive industrial equipment used in manufacturing settings with tight tolerances).

Implementation of Commissioning and Qualification (C&Q) may involve testing protocols to validate that equipment, processes, and/or other aspects satisfy criteria and/or standards. Executing a series of protocols associated with a type of test and/or operation for laboratory equipment may assist in reaching criteria. The protocols may include test cases that include step-by-step instruction to execute a given protocol. The test cases may outline given conditions to test equipment and/or processes. The test cases may also include associated outcomes (e.g., results of the test cases) and/or criteria to evaluate performance.

Generation of protocols to test laboratory equipment and/or processes may involve extensive review by engineers and/or equipment operators based on User Requirement Specification (URS) documentation. Depending on the equipment, process, and/or experience of individuals, generation of protocols may be an exhaustive task. Furthermore, manual generation of protocols is prone to error and/or miscalculations. Errors in protocols may result in lost product and/or wasted energy consumption. Additionally, miscalculations may lead to selection of equipment having capabilities that differ from identified capabilities within a given URS.

Some technical solutions of the present disclosure include implementation of Machine Learning (ML) models to generate protocols based on URS document. Various systems and/or methods described herein may implement ML models to generate protocols to test performance of laboratory equipment and/or processes. ML models trained to generate protocols may reduce errors and/or miscalculations in protocol generation by utilizing contextual data that is absent from manual generation of protocols. For example, ML models may be fed laboratory equipment manuals and/or performance guidelines to use when generating protocols.

Moreover, the ML models may reduce an amount of time to generate protocols which results in quicker implementation of laboratory equipment. A reduction in the amount of time to implement laboratory equipment may assist to achieve reductions in time-to-market to various types of medications and/or products. Additionally, generation of protocols, via ML models, may yield reductions in carbon emissions and/or energy consumption. For example, implementation of tests cases that included errors may result in repetition and/or reiteration of the test cases which results in additional energy consumption.

The ML models may be fed prompts including URS documents and/or inputs, and the ML models may output responses including test cases that correspond to the prompts. Additionally, providing a user interface which includes interactions between a user and the ML models may provide a step-by-step process to guide the user through protocol generation. Given various regulations and/or sensitivity of data within the life science industry, implementation of third-party ML models may not be appropriate. As such, some of the systems and/or methods described herein may implement closed loop ML models that are housed within and/or associated with a closed loop system.

The systems and/or methods described herein may also be implemented in and/or assist with generation and/or review of at least one of Installation Qualification Protocols, Operational Qualification Protocols, Process Qualification Protocols, Standard Operating Procedures, Work Instructions, and/or Configuration Management Specifications. The systems and/or methods described herein may also assist in reviewing and/or modifying document. For example, the systems and/or methods described herein may assist with reviewing at least one of test cases, protocols, standard operating procedures, indicating reviewer errors, issues in testing methodologies, ambiguities, unclear testing, efficacy of testing step, and/or pre-requisites.

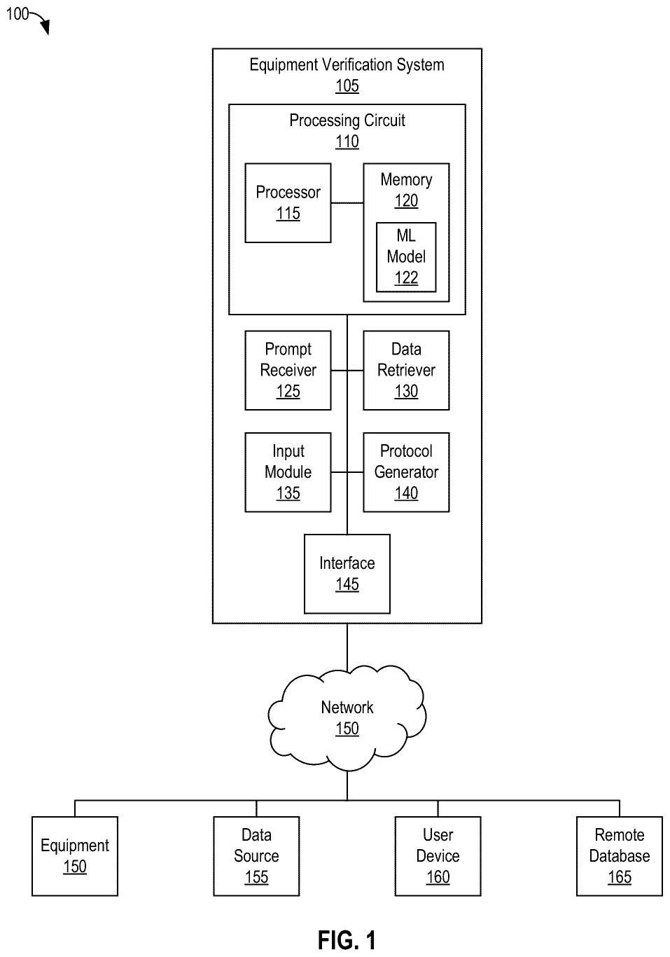

FIG. 1 depicts a block diagram of system 100, according to some embodiments. In some embodiments, the system 100 and/or one or more components thereof may implement and/or include a closed-loop system. Each system and/or component of the system 100 can include one or more processors, memory, network interfaces, communication interfaces, and/or user interfaces. Memory can store programming logic that, when executed by the processors, controls the operation of the corresponding computing system or device. Memory can also store data in databases. The network interfaces can allow the systems and/or components of the system 100 to communicate wirelessly. The communication interfaces can include wired and/or wireless communication interfaces and the systems and/or components of the system 100 can be connected via the communication interfaces. The various components in the system 100 can be implemented via hardware (e.g., circuitry), software (e.g., executable code), or any combination thereof. Systems, devices, and components in FIG. 1 can be added, deleted, integrated, separated, and/or rearranged.

In some embodiments, the system 100 may include at least one Equipment Verification System (EVS) 105, at least one network 150, at least one piece of equipment 152, at least one data source 155, at least one user device 160, and at least one remote database 165. In some embodiments, the system 100 and/or one or more systems, devices, and/or components thereof may implement at least one of the various techniques described herein to generate protocols to test laboratory equipment and/or processes.

In some embodiments, the network 150 may include at least one of a local area network (LAN), wide area network (WAN), telephone network (such as the Public Switched Telephone Network (PSTN)), Controller Area Network (CAN), wireless link, intranet, the Internet, a cellular network, and/or combinations thereof. In some embodiments, the various systems, components, and/or devices included in the system 100 may communicate with one another via the network 150.

In some embodiments, the pieces of equipment 152 and/or equipment 152 may refer to and/or include at least one of laboratory equipment, manufacturing equipment, industrial equipment, pharmaceutical equipment, and/or circuitry design equipment. In some embodiments, the equipment 152 may include at least one of a single-use bioreactor, a high performance liquid chromatography system, a single-use fermenter, a distributed control system, an aseptic filling machine, a centrifuge, a chromatography skid, an extreme ultraviolet lithography system, an advanced thin-film deposition tool, and/or an advanced metrology and defect inspection tool. In some embodiments, protocols may be generated to test and/or evaluate the equipment 152.

In some embodiments, the data source 155 may provide and/or include information associated with and/or corresponding to the equipment 152. For example, the data sources 155 may provide equipment manuals associated with the equipment 152. As another example, the data sources 155 may provide regulations and/or guidelines that pertain to the equipment 152. In some embodiments, the data sources 155 may include at least one of online resources, publicly accessible information sources, Application Programming Interface (API) messages, data registries, and/or other possible sources. In some embodiments, the data sources 155 may provide one or more sets of information associated with the equipment 152. The sets of information may include at least one of equipment specification sheets, journals, publications, design documents, requirement documents, drawings, process flow diagrams, sequential flow charts, and/or control system code.

In some embodiments, the user device 160 may perform various actions and/or access various types of information. The information may be provided over the network 150. In some embodiments, the user device 160 may perform similar functionality to that of at least one system, device, and/or component of the system 100. For example, the user device 160 may perform similar operations to that of the EVS 105. In some embodiments, the user device 160 may include one or more applications to receive information, display information, and/or receive user interactions with content displayed by the user device 160.

In some embodiments, the user device 160 may include at least one of a screen, a monitor, a visual display device, a touchscreen display, a television, a video display, a liquid crystal display (LCD), a light emitting diode (LED) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the user device 160 may include displays that include a resistive touchscreen that can receive user input via interactions (e.g., touches) with the touchscreen.

In some embodiments, the remote database 165 may include at least one of a computing device, a remote server, a server bank, a remote device, and/or among other possible computer hardware and/or computer software. For example, the remote database 165 may include a server bank and the server bank can store, keep, maintain, and/or otherwise hold the various types of information described herein. In some embodiments, the remote database 165 may house and/or otherwise implement at least one of the various systems, devices, and/or components described herein. In some embodiments, the remote database 165 may include, store, maintain, and/or otherwise host the EVS 105. For example, the EVS 105 may be distributed across one or more servers (e.g., the remote database 165). In some implementations, the EVS 105 and/or various other components of the system 100 (e.g., the data source 155 and/or remote database 165) may be implemented using cloud computing services/platforms.

In some embodiments, the EVS 105 may include at least one processing circuit 110, at least one prompt receiver 125, at least one data retriever 130, at least one input module 135, at least one protocol generator 140, and at least one interface 145. The processing circuit 110 may include at least one processor 115 and memory 120. In some embodiments, the processing circuit 110 and/or one or more components thereof (e.g., the processors 115 and memory 120) may perform similar functionality to that of the EVS 105 and/or one or more components thereof. For example, memory 120 may store programming logic that, when executed by the processors 115, cause the processors 115 to perform functionality similar to the EVS 105.

In some embodiments, the processing circuit 110 may be communicably connected to one or more components of the EVS 105. For example, the processing circuit 110 may be communicably connected to the interface 145. In some embodiments, the processors 115 may be implemented as a general-purpose processor, an application specific integrated circuit (ASIC), one or more field programmable gate arrays (FPGAs), a group of processing components, or other suitable electronic processing components.

In some embodiments, memory 120 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 120 may be or include volatile memory or non-volatile memory. Memory 120 may include database components, object code components, script components, or any other type of information structure for supporting the various activities and information structures described in the present application. According to an exemplary embodiment, memory 120 is communicably connected to the processors 115 via the processing circuit 110 and memory 120 includes computer code for executing (e.g., by the processing circuit 110 and/or the processors 115) one or more processes described herein.

In some embodiments, memory 120 may store, keep, hold, and/or otherwise maintain at least one ML model 122. The ML model 122 may be trained using one or more various ML and/or Artificial Intelligence techniques. For example, the ML model 122 may be trained using supervised and/or unsupervised learning. In some embodiments, one or more components of the EVS 105 may access and/or utilize the ML model 122. For example, the processors 115 may utilize the ML model 122. In some embodiments, the ML model 122 is trained to generate one or more protocols and/or test cases described herein.

In some embodiments, the ML model 122 may refer to and/or include Generative Artificial Intelligence (GAI). For example, the ML model 122 may include a generative pre- trained transformer. In some embodiments, the generative pre-trained transformer (e.g., the ML model 122) may generate one or more protocols that were absent from training data used to train the ML model 122. For example, the generative pre-trained transformer may be trained to create protocols (e.g., generate protocols) instead of or in addition to retrieving and/or identifying protocols that were included in training data. In some implementations, the ML model 122 may generate new protocols that do not exist within data sources available to the ML model 122, regardless of whether the data was used to train the ML model 122 (e.g., may generate new, non- preexisting protocols).

In some embodiments, the interface 145 may include at least one of network communication devices, network interfaces, and/or other possible communication interfaces. The interface 145 may include wired or wireless communications interfaces (e.g., jacks, antennas, transmitters, receivers, transceivers, wire terminals, etc.) for conducting data communications with various systems, devices, and/or components described herein. The interface 145 may be direct (e.g., local wired or wireless communications) and/or via a communications network (e.g., the network 150). For example, the interface 145 may include an Ethernet card and port for sending and receiving data via an Ethernet-based communications link or network. The interface 145 may also include a Wi-Fi transceiver for communicating via a wireless communications network (e.g., the network 150). The interface 145 may include a power line communications interface. The interface 145 may include an Ethernet interface, a USB interface, a serial communications interface, and/or a parallel communications interface.

In some embodiments, the EVS 105 may generate, produce, provide, and/or otherwise display at least one user interface. For example, the EVS 105 may display at least one Graphical User Interface. In some embodiments, the EVS 105 may transmit one or more signals that cause one or more devices to display a user interface. For example, the interface 145 may transmit signals, to the user device 160, that cause the user device 160 to display a user interface.

In some embodiments, the EVS 105 may receive one or more indications and/or messages responsive to interactions with the user interfaces. For example, the EVS 105 may receive indications responsive to selections of one or more icons included in a user interface. In some embodiments, the EVS 105 may receive, via the interface 145, one or more messages from the various systems, devices, and/or components described herein.

In some embodiments, the prompt receiver 125 may receive one or more prompts. For example, the prompt receiver 125 may receive prompts that were entered into and/or provided to a user interface. As another example, the prompt receiver 125 may receive one or more prompts from the interface 145. In some embodiments, the prompt receiver 125 may receive a prompt to generate one or more protocols. For example, the prompt receiver 125 may receive a prompt to generate a protocol to test performance of a piece of equipment 152.

In some embodiments, the prompt may include information. For example, the prompt may include information to identify the piece of equipment 152. In some embodiments, the information may include at least one of a serial number, a model number, a device name, a device type, and/or specification information. The prompt may also include information to identify an operational condition for the piece of equipment 152. For example, the prompt may include information that identifies a given Rotation Per Minute (RPM) value for the equipment 152. As another example, the prompt may include information that identifies a capacity for the equipment 152.

In some embodiments, the information included in the prompt may include at least one of a temperature control value (e.g., heating and/or cooling), a size (e.g., volume, capacity, dimension), controller parameters, wattage values, spin rates, discharge rates, accessory ports, equipment materials, finishings, compliance ratings, weight capacity, runtime ratings. In some embodiments, the operational condition for the equipment 152 may include at least one of a runtime for the equipment 152, a capacity for the equipment 152, a temperature value for the equipment 152, a temperature range for the equipment 152, a material composition of equipment 152, an agitation speed for the equipment 152, a pressure value for the equipment 152, a pressure range for the equipment 152, a flow value for the equipment 152, a flow range for the equipment 152, a conductivity value for the equipment 152, a moisture value for the equipment 152, and/or a moisture range for the equipment 152.

In some embodiments, the prompt receiver 125 may communicate with one or more components of the EVS 105, responsive to receiving the prompts. For example, the prompt receiver 125 may communicate with the interface 145. In some embodiments, the prompt receiver 125 may transmit, via the interface 145, one or more signals to the user device 160. For example, the prompt receiver 125 may transmit signals that cause the user device 160 to update a user interface. To continue this example, the user interface may be updated to display an indication that the prompt receiver 125 received the prompt.

In some embodiments, the data retriever 130 may receive, from the prompt receiver 125, information that was included in the prompt. For example, the data retriever 130 may receive information that identifies the equipment 152. In some embodiments, the data retriever 130 may retrieve one or more sets of information. For example, the data retriever 130 may retrieve information associated with the equipment 152. As another example, the data retriever 130 may retrieve information associated with the operational condition of the equipment 152.

In some embodiments, the data retriever 130 may retrieve the information from at least one of the data source 155 and/or the remote database 165. For example, the data retriever 130 may transmit, via the interface 145, one or more API calls to the data sources 155 to retrieve the information. In some embodiments, the data retriever 130 may retrieve information that corresponds to the information included in the prompt. For example, the prompt may include a serial number for the equipment 152 and the data retriever 130 may retrieve information that corresponds to the serial number. In some embodiments, the information retrieved by the data retriever 130 may include at least one of laboratory equipment specification sheets, laboratory journals, or publications.

In some embodiments, the data retriever 130 may provide the one or more sets of information to the input module 135. For example, the data retriever 130 may provide, to the input module 135, information as the data retriever 130 receives and/or obtains the information. In some embodiments, the input module 135 may input the one or more sets of information into the ML model 122. For example, the input module 135 may provide the one or more sets of information to the ML model 122. In some embodiments, the input module 135 may provide the one or more sets of information by retrieving and/or accessing, in memory 120, the ML model 122. The input module 135 may communicate with and/or interface with the protocol generator 140, responsive to inputting the one or more sets of information into the ML model 122.

In some embodiments, the protocol generator 140 may generate one or more protocols. For example, the protocol generator 140 may generate protocols to test the performance of the equipment 152. In some embodiments, the protocol generator 140 may generate the protocols using the ML model 122. For example, the protocol generator 140 may implement and/or access the ML model 122 to generate the protocols. In some embodiments, the ML model 122 may generate the protocols based on the one or more sets of information. For example, the ML model 122 may generate the protocols based on the information retrieved by the data retriever 130.

In some embodiments, the protocol generator 140 may provide the protocols to the interface 145. For example, the protocol generator 140 may provide the protocols, responsive to generating the protocols. In some embodiments, the interface 145 may provide the protocols to one or more systems, devices, and/or components. For example, the interface 145 may provide the protocols to the user device 160. In some embodiments, the interface 145 may transmit one or more signal responsive to generation of the protocols. For example, the interface 145 may transmit one or more signals to cause a user interface to display the protocol. As another example, the interface 145 may transmit one or more signals to cause the user device 160 to display a user interface that includes the protocols. In some embodiments, the interface 145 may provide the protocols as a response to the prompt. For example, the protocols may be included in a response that is provided to the user device 160.

In some embodiments, the interface 145 may receive one or more selections. For example, the interface 145 may receive one or more signals that indicate and/or identify selections on a user interface. As another example, the interface 145 may receive signals that indicate given icons and/or elements that were selected on a user interface. In some embodiments, the interface 145 may receive, responsive to displaying the protocol, a selection via the user interface to indicate acceptance of the protocol. For example, the interface 145 may receive one or more signals that indicate selection of an accept icon and/or an accept element.

In some embodiments, the interface 145 may transmit one or more signals, responsive to receipt of the selections. For example, the interface 145 may transmit one or more signals to the equipment 152. In some embodiments, the interface 145 may transmit one or more signals that causes the equipment 152 to execute one or more actions. For example, the interface 145 may transmit control signals to the equipment 152. In some embodiments, the EVS 105 may execute, responsive to receipt of the selections, one or more actions to initiate implementation of the protocol. For example, the protocol may include testing a drainage time for the equipment 152 and the EVS 105 may execute one or more actions to cause the equipment 152 to perform a drain cycle.

In some embodiments, the EVS 105 may execute, perform, and/or implement one or more aspects of the protocols. For example, the EVS 105 may transmit control signals to cause the equipment 152 to perform one or more operations. In some embodiments, the interface 145 may receive, responsive to execution of the protocol, one or more observed performances. For example, the interface 145 may receive observed performances of the equipment 152. In some embodiments, the observed performances of the equipment 152 may refer to and/or include measured and/or calculated values. For example, the observed performances of the equipment 152 may include a measured RPM value for the equipment 152. As another example, the observed performances of the equipment 152 may include an internal temperature of a reservoir within the equipment 152.

In some embodiments, the EVS 105 may compare the observed performances with the operational conditional. For example, the operational condition may identify that the equipment 152 perform a drain cycle in X amount of time and the observed performance of the equipment 152 may include a measured amount of time to complete the drain cycle. As another example, the operational condition may identify temperature variance value and the observed performance may include a measured temperature range. In some embodiments, the EVS 105 may determine one or more performances of the equipment 152. For example, the EVS 105 may determine, responsive to comparing the observed performance of the equipment 152 with the operational condition of the equipment 152, the performance of the equipment 152. Stated otherwise, the EVS 105 may determine whether the equipment 152 followed and/or meet one or more aspects of the operational condition.

In some embodiments, the operational conditions may include one or more values. For example, the operational conditions may include one or more RPM values, one or more temperature ranges, one or more temperature setpoints, one or more capacity values, and/or among other values. In some embodiments, the observed performance of the equipment 152 may include measured, calculated, and/or observed values. For example, the observed values may include an observed drain time for the equipment 152, a measured RPM value for the equipment 152, and/or other observed values.

In some embodiments, the EVS 105 may detect one or more differences between the values for the operational conditions and the observed values. For example, the EVS 105 may detect a difference between an RPM value for the equipment 152 and an observed RPM value for the equipment 152. In some embodiments, the EVS 105 may retrain the ML model 122 based on the one or more differences.

In some embodiments, the data retriever 130 may determine one or more formats of the sets of information. For example, the data retriever 130 may determine the formats responsive to retrieval of the sets of information. In some embodiments, the data retriever 130 may retrieve information that includes and/or is provided in one or more formats. For example, the data retriever 130 may retrieve information that is included in a table (e.g., a first given format) and information that is sentence based (e.g., a second given format). In some embodiments, the EVS 105 may detect one or more differences between the formats of the sets of information. For example, the EVS 105 may detect that a first set of information is in a first format and that a second set of information is in a second format. In some embodiments, the EVS 105 may detect differences between formats of the one or more sets of information and a format associated with the ML model 122.

In some embodiments, the EVS 105 may modify the one or more sets of information to reflect the format of the ML model 122. For example, the format of the ML model 122 may be tables and/or graphs and the EVS 105 may modify the format of the one or more sets of information to be in table and/or graph format. In some embodiments, the input module 135 may input, into the ML model 122, the one or more sets of information, responsive to the EVS 105 modifying the format of the one or more sets of information.

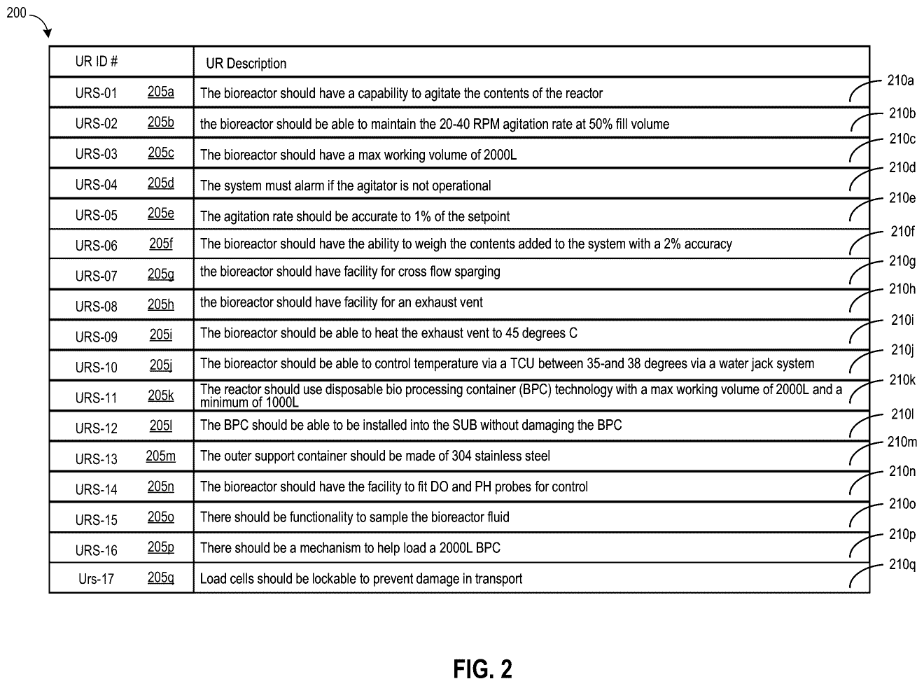

FIG. 2 depicts a table 200, according to some embodiments. In some embodiments, the table 200 may be provided with the prompt to generate the protocol to test the performance of the equipment 152. For example, the table 200 may be provided and/or entered into a user interface and the table 200 may be provided to the EVS 105. In some embodiments, the table 200 may include at least one operational condition 205. The operational conditions 205 may refer to and/or the URSs described herein. As shown in FIG. 2, the table 200 includes operational conditions 205a-205q. In some embodiments, the operational conditions 205a-205q may include corresponding entries and/or descriptions (shown as descriptions 210a-210q). The descriptions 210a-210q may specify and/or identify one or more characteristics and/or values for the operational conditions 205a-205q. For example, description 210a is shown to identify that operational condition 205a pertains to an agitation rate for a bioreactor (e.g., a given piece of equipment 152). In some embodiments, the EVS 105 may use the information included in the table 200 to generate one or more protocols.

In an illustrative example, a user may provide or enter a table that includes one or more operational conditions 205 associated with one or more URSs for an Extreme Ultraviolet (EUV) lithography system. To continue this example, the URS may include at least one of the following operational conditions 205: (1) an EUV light source may generate light having a wavelength of 13.5 nanometers with an exposure time of 60 seconds or less, (2) the EUV light source may provide dose stability at or above 0.3% for an 8 hour time period, (3) an EUV scanner may be able to pattern features down to 5 nanometers, (4) the EUV scanner may have an overlay accuracy of less than 1.5 nanometers 3 sigma, (5) the EUV scanner may have a focus accuracy of less than 2.5 nanometers 3 sigma, (6) the EUV scanner may achieve 150 wafer per hour, (7) the EUV scanner may handle wafer sizes up to 450 nanometers is diameter, (8) the EUV scanner may have an availability of 90%, (9) the EUV scanner may detect defects down to 10 nanometers in size, (10) the EUV scanner may have automated substrate handling that minimizes particle generation, (11) the EUV scanner may have facilities for mask inspection and pellicle protection, (12) the EUV scanner may be compatible with chemically amplified photoresists, and/or (13) the EUV scanner may have an 80 Kilo-Electron volt (KeV) for EUV mask defect inspection. It should be appreciated that this is merely one illustrative example, and in various implementations the features described herein can be used to generate test cases for any type of equipment.

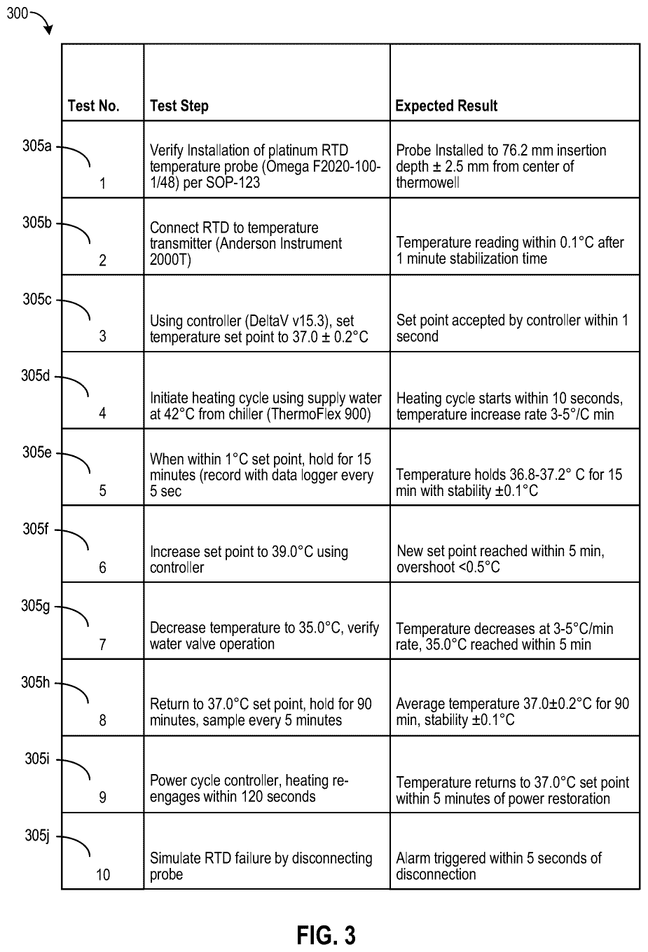

FIG. 3 depicts a table 300, according to some embodiments. In some embodiments, the table 300 may represent and/or include the protocols described herein. For example, the table 300 may include protocols generated by the protocol generator 140. In some embodiments, the table 300 may include at least one test 305. The tests 305 may refer to and/or include a given action and/or task associated with the equipment 152. For example, the tests 305 may include a temperature control scheme to implement when testing the equipment 152. As shown in FIG. 3, the table 300 includes tests 305a-305j. The tests 305a-305j are shown to include entries to identify a test step and an expected result. In some embodiments, the tests step may identify given actions to take with respect to the equipment 152. In some embodiments, the expected results may refer to and/or include the one or more values of the operational conditions described herein.

In an illustrative example, the table 300 may include at least one of the following tests 305 or expected results: (1a) inspect water jacket and verify no leaks or damage per equipment maintenance manual, (1b) no leaks or damage present, (2a) verify calibration certificate for temperature probe, (2b) calibration certificate is present, (3a) connect calibrated temperature probe to temperature controller per controller manual, (3b) connection successful and controller recognizes temperature probe, (4a) turn on main power to single use bioreactor per operating manual, (4b) main power switch is illuminated, (5a) set temperature controller to given temperature value or given temperature range, (5b) controller setpoint shows given temperature value or given temperature range, (6a) engage temperature control system and start heating per operating manual (6b) heating system activates, (7a) monitor temperature until given temperature value or given temperature range is met, (7b) given temperature value or given temperature range is reached, (8a) adjust controller setpoints to second given temperature value or second given temperature range, (8b) controller setpoints changes to second given temperature value or second given temperature range, (9a) monitor the temperature until second given temperature value or second given temperature range is met, (9b) second given temperature value or second given temperature range is reached, (10a) adjust temperature controller setpoint to third given temperature value or third given temperature range, (10b) controller setpoints changes to third given temperature value or third given temperature range, (11a) monitor the temperature until third given temperature value or third given temperature range is met, (11b) third given temperature value or third given temperature range is reached, (12a) return temperature controller to off position per operating manual, (12b) heating system deactivates, (13a) verify test records are complete and archived per quality manual, and/or (13b) records archived successfully. It should be appreciated that this is merely one illustrative example, and in various implementations the features described herein can be used to generate test cases for any type of equipment.

In another illustrative example, the table 300 may include one or more steps that correspond to test case based on one or more URSs for an EUV lithography system. To continue this example, the table may include at least one of the following steps and/or expected results: (1a) inspect a light source chamber and optics for an visible contamination or damage per an equipment maintenance manual, (1b) no contamination or damage visible, (2a) confirm calibration of in-band power meter per calibration certificate, (2b) calibration certificate is current and valid, (3a) power up EUV light source per operating manual, monitor chamber pressure, and ensure that vacuum level reaches given torr value, (3b) chamber pressure decreases and/or reaches given torr value, (4a) initiate ignition sequent per operating manual (4b) EUV output power reaches given wattage value, (5a) adjust drive lase pulse energy to set EUV output to given wattage level or given wattage range, (5b) EUV power maintains given wattage level or given wattage range, (6a) extract a portion of the EUV light and measure spectrum using calibrated spectrometer per operating manual, (6b) wavelength peak is centered at given wavelength value or wavelength range, (7a) set exposure time to given amount of time, expose calibration wafer, and develop per lithography manual, (7b) features are imaged on wafer, (8a) set exposure time to a second given amount of time, expose calibration wafer, and develop per lithography manual, (8b) features are imaged on wafer, (9a) confirm test records and archive records per quality manual, and/or (9b) records archived successfully. It should be appreciated that this is merely one illustrative example, and in various implementations the features described herein can be used to generate test cases for any type of equipment.

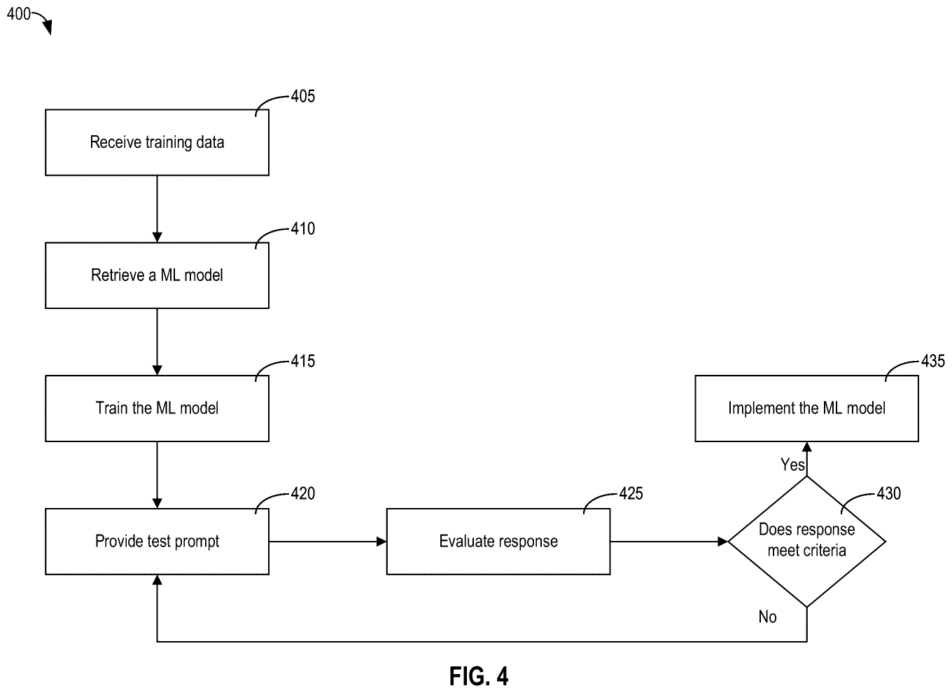

FIG. 4 depicts a flow chart of a process 400 to train one or more ML models, according to some embodiments. In some embodiments, the ML model 122 may be trained and/or retrained using the process 400. At least one step of the process 400 may be performed by at least one of the various systems, devices, and/or components described herein. For example, the EVS 105 may perform at least one step of the process 400. In some embodiments, at least one step of the process 400 may be repeated, reproduced, reimplemented, and/or otherwise duplicated. In some embodiments, memory 120 may store instructions that, when executed by the processors 115, cause the processors 115 to perform at least one step of the process 400.

In some embodiments, step 405 may include receiving training data. For example, the interface 145 may receive the training data. In some embodiments, the interface 145 may receive the training data from the data sources 155. The training data may include at least one of protocols, operational conditions, and/or observed performances. For example, the training data may include operational conditions associated with one or more types of equipment (e.g., equipment 152). In some embodiments, the training data may link and/or associate operational conditions with respective protocols. For example, the training data may specify that a given operational condition is associated with a given protocol.

In some embodiments, receiving the training data may include obtaining the training data. For example, the interface 145 may obtain the training data from the user device 160. In some embodiments, the interface 145 may obtain the training data responsive to the training data being provided by the user device 160.

In some embodiments, step 410 may include retrieving a ML model. For example, the EVS 105 may retrieve the ML model 122 from memory 120. In some embodiments, retrieving the ML model 122 may include accessing and/or interfacing with the ML model 122. The EVS 105 may retrieve the ML model 122 responsive to receiving the training data in step 405.

In some embodiments, step 415 may include training the ML model. For example, the EVS 105 may train the ML model 122 using the training data received in step 405. In some embodiments, the EVS 105 may train the ML model 122 may inputting a first portion of the training data into the ML model 122. In some embodiments, the first portion of the training data may include one or more prompts and one or more protocols generated based on the prompts. For example, the first portion of the training data may include a first prompt and a first protocol generated based on the first prompt. In some embodiments, the first portion of the training data may include at least one of one or more first protocols included in the training data, one or more first operational conditions included in the training data, and one or more first observed performances included in the training data.

In some embodiments, the EVS 105 may reserve and/or separate one or more second portions of the training data to use when evaluating the ML model 122. For example, the EVS 105 may reserve a second portion of the training data. In some embodiments, the second portion of the training data may include at least one of one or more second protocols included in the training data, one or more second operational conditions included in the training data, and/or one or more second observed performances included in the training data.

In some embodiments, the EVS 105 may train the ML model 122 using one or more ML and/or AI training techniques. In various embodiments, the ML model 122 may be or include regression trees, deep neural networks, nearest neighbor-based models, supervised learning- based models, unsupervised learning-based models, Bayesian models, generative AI models such as transformer (e.g., generative pretrained transformer (GPT)) models or generative adversarial network (GAN) models or other large language models (LLMs), and/or other types of models.

In some embodiments, step 420 may include providing a test prompt. For example, the EVS 105 may provide the test prompt to the ML model 122 responsive training the ML model 122 in step 420. In some embodiments, the test prompt may include information to identify a given piece of equipment 152 as well as an operational condition for the given piece of equipment 152. For example, the test prompt may include information that was included in the second portion of the training data described herein. In some embodiments, the second portion of the training data may include a prompt as well as a generated protocols based on the prompt.

In some embodiments, the EVS 105 may receive a response from the ML model 122. For example, the EVS 105 may receive a protocol that was generated by the ML model 122. In some embodiments, the response may include a protocol that was generated, by the ML model 122, based on the test prompt provided to the ML model 122.

In some embodiments, step 425 may include evaluating the response. For example, the EVS 105 may evaluate the response that was generated by the ML model 122. In some embodiments, the EVS 105 may evaluate the response by comparing the protocol generated by the ML model 122 with the protocol included in the second portion of the training data. The EVS 105 may evaluate the response by determining a number of iterations and/or predictions performed by the ML model 122. For example, the EVS 105 may determine if the response, received, in step 425, is a first response and/or subsequent response to a given test prompt.

In some embodiments, step 420 may include determining if the response meets given criteria. For example, the EVS 105 may determine if the response that was evaluated in step 425 meets criteria associated with generating prompts. In some embodiments, the ML model 122 may be evaluated and/or trained by inputting the same test prompt into the ML model 122 multiple times and then comparing the subsequent responses generated after each time the test prompt was inputted. In some embodiments, the process 400 may return to step 420 responsive to a determination that the response does not meet the criteria. In some embodiments, the process 400 may proceed to step 435 responsive to a determination that the response does meet the criteria.

In some embodiments, step 420 may also include identifying a status of the ML model. For example, the EVS 105 may determine that the responses generated by the ML model 122 meet a given threshold. As another example, the EVS 105 may determine that subsequent training (e.g., retraining) be performed.

In some embodiments, step 435 may include implementing the ML model. For example, the EVS 105 may implement and/or utilize the ML model 122 to generate one or more protocols based on prompts received by the interface 145. Stated otherwise, the ML model 122 may be accessible to end users to generate protocols to test performance of the equipment 152.

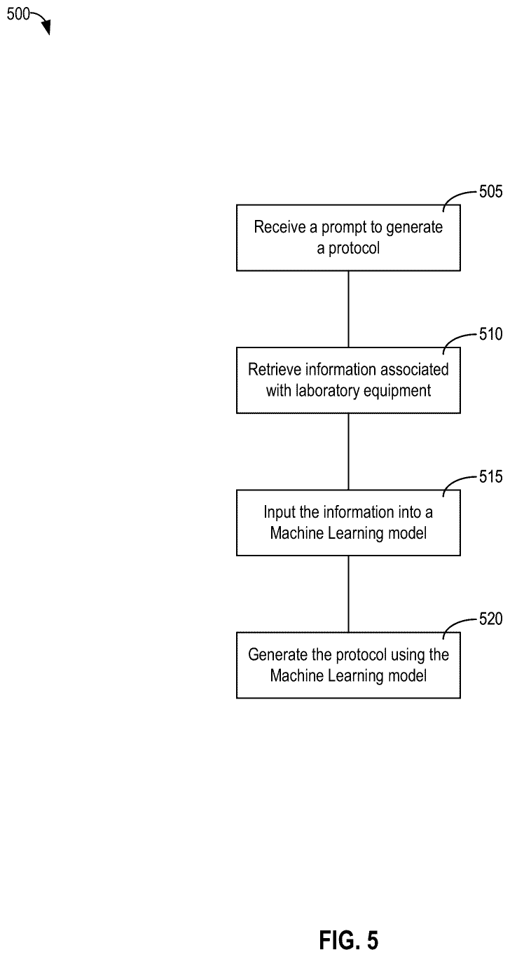

FIG. 5 depicts a flow diagram of a process 500 to generate protocols to test one or more pieces of equipment, according to some embodiments. In some embodiments, the process 500 may be performed responsive to implementation of the ML model 122. For example, the process 500 may be performed responsive to the implementation of the ML model 122 in step 435 of the process 400. In some embodiments, at least one step of the process 500 may be performed by at least one of the various systems, devices, and/or components described herein. For example, the EVS 105 may perform at least one step of the process 500. In some embodiments, at least one step of the process 500 may be repeated, reproduced, reimplemented, and/or otherwise duplicated. In some embodiments, memory 120 may store instructions that, when executed by the processors 115, cause the processors 115 to perform at least one step of the process 500.

In some embodiments, step 505 may include receiving a prompt to generate a protocol. For example, the prompt receiver 125 may receive the prompt from the user device 160. In some embodiments, the prompt receiver 125 may receive the prompt responsive to a user entering and/or providing information associated with the prompt into a user interface. The prompt received in step 505 may include prompting the EVS 105 to generate a protocol to test performance of a piece of manufactory or laboratory equipment. For example, the prompt may be to generate a protocol to test the performance of a piece of equipment 152.

In some embodiments, the prompt may include information to identify the equipment 152 and/or an operational condition for the equipment 152. For example, the prompt may include information that identifies a serial number of the equipment 152. As another example, the prompt may include information that identifies a temperature rating for the equipment 152.

In some embodiments, step 510 may include retrieving information associated with laboratory equipment. For example, the data retriever 130 may retrieve information associated with equipment 152 identified in step 505. In some embodiments, the data retriever 130 may retrieve one or more sets of information associated with the equipment 152 and/or the operational condition of the equipment 152. For example, the data retriever 130 may retrieve information from the data sources 155. In some embodiments, the data retriever 130 may retrieve the information responsive to receipt of the prompt in step 505.

In some embodiments, step 515 may include inputting the information into a Machine Learning (ML) model. For example, the input module 135 may input the information, retrieved in step 510, into the ML model 122. In some embodiments, the input module 135 may input the information, responsive to the input module 135 accessing the ML model 122. In some embodiments, the input module 135 may also provide (e.g., input) the prompt, received in step 505, to the ML model 122.

In some embodiments, step 520 may include generating the protocol using the ML model. For example, the protocol generator 140 may generate the protocol using the ML model 122. In some embodiments, the ML model 122 may generate the protocol based on the information retrieved in step 510. For example, the ML model 122 may generate the protocol based on the information retrieved by the data retriever 130. In some embodiments, the ML model 122 may generate the protocol that was associated with the prompt received in step 505. For example, the prompt, received in step 505, may have been a prompt to generate a protocol to test performance of a given piece of equipment 152. To continue this example, the ML model 122 may generate the protocol to test the performance of the given piece of equipment 152.

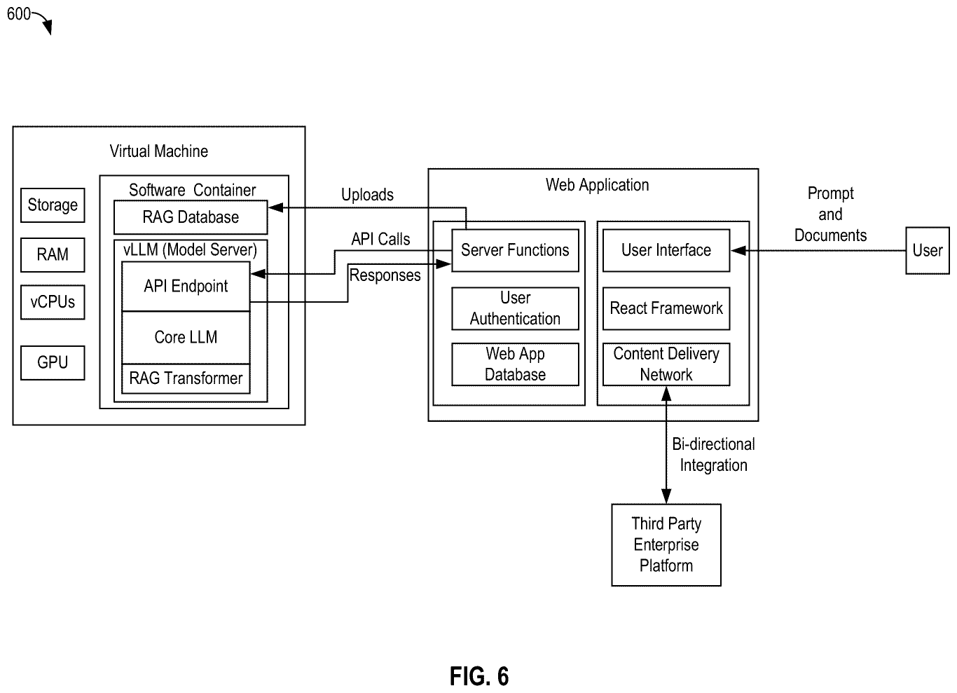

FIG. 6 depicts a block diagram of a system architecture 600, according to some embodiments. In some embodiments, the system architecture 600 may refer to and/or include the system 100 and/or one or more components thereof. For example, the system architecture 600 may include the EVS 105. In some embodiments, the system architecture 600 may include at least one web application, at least one virtual machine, at least one third party enterprise platform, and at least one user device. While the system architecture 600, as shown in FIG. 6, includes various systems, devices, and/or components, the illustration of FIG. 6 is in no way limiting. For example, in some embodiments, one or more systems, devices, and/or components may be omitted and/or added. As shown in FIG. 6, the web application may interface and/or communicate with the user device and/or the third party enterprise platform. For example, content delivery network may establish bi-directional integration between the web application and the third party enterprise platform. As another example, the user device may communicate prompts and/or documents, via user interface of the web application, to the web application.

As shown in FIG. 6, the web application is shown to include server functions such as uploads, API calls, and responses. For example, the server functions may include providing uploads to the Retrieval Augmented Generation (RAG) of the virtual machine. As another example, the server functions may include transmitting API calls to an API endpoint of the virtual machine. As even another example, the server functions may include receiving responses to the API calls.

In some embodiments, the virtual machine may include a computing system that enables applications to run within a network infrastructure. In some embodiments, Virtual Central Processing Unit (vCPU) may include cores that enable the virtual machine to run and/or execute one or more threads concurrently. In some embodiments, Graphical Processing Unit (GPU) may provide parallel processing. In some embodiments, software container may include a unit of software that packages code (e.g., software, firmware, instructions, executable code, etc.) In some embodiments, an API may act as a messenger to deliver information between one or more applications. In some embodiments, an API endpoint may include a Uniform Resource Locator (URL) that receives API calls and/or requests, and that also sends responses. In some embodiments, a very Large Language Model (vLLM) may include a library for LLM inference and may also connect LLMs with external applications. In some embodiments, a transformer may include a deep learning model that may perform summarization or keyword extraction. In some embodiments, the content delivery network may refer to and/or include a distributed network of servers that delivers images and/or scripts. In some embodiments, RAG may refer to and/or include retrieving information from external sources and feeding the retrieved information into one or more LLMs.

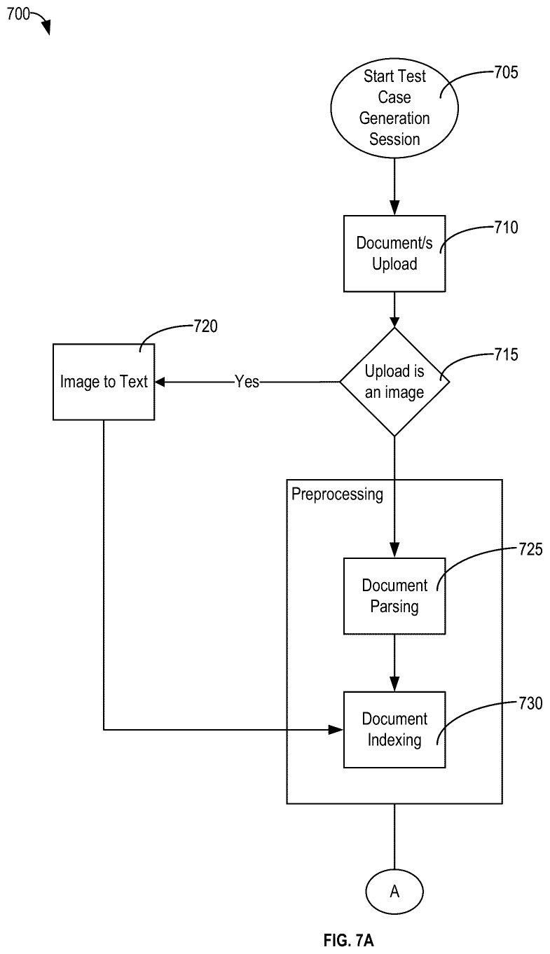

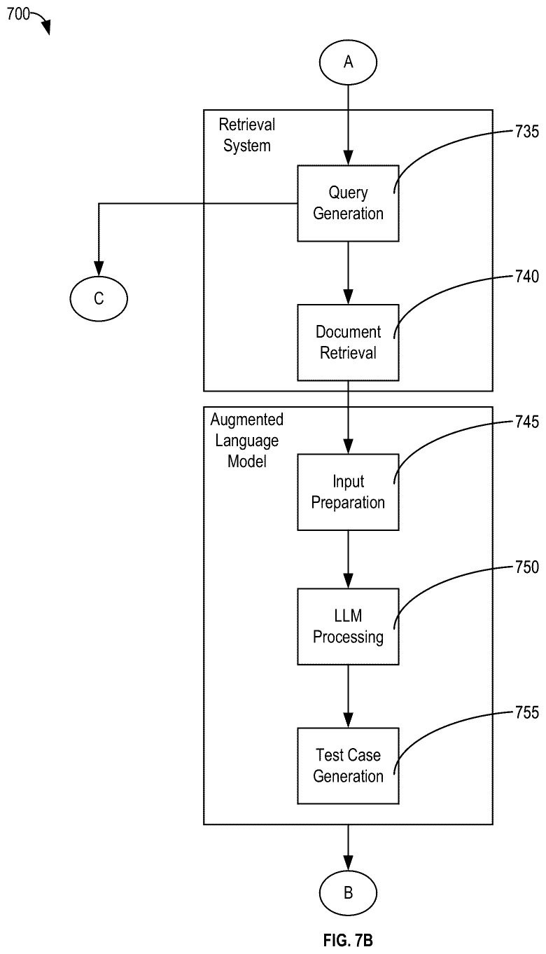

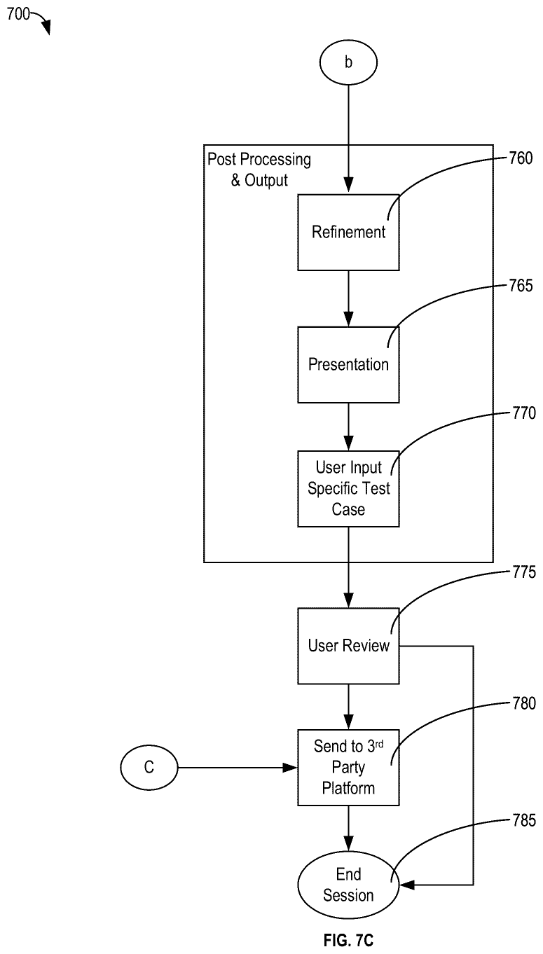

FIG. 7A depicts a flow diagram of a process 700 to generate one or more protocols, according to some embodiments. In some embodiments, the process 700 may be performed responsive to implementation of the ML model 122. For example, the process 700 may be performed responsive to the implementation of the ML model 122 in step 435 of the process 400. In some embodiments, at least one step of the process 700 may be performed by at least one of the various systems, devices, and/or components described herein. For example, the EVS 105 may perform at least one step of the process 700. In some embodiments, at least one step of the process 700 may be repeated, reproduced, reimplemented, and/or otherwise duplicated. In some embodiments, memory 120 may store instructions that, when executed by the processors 115, cause the processors 115 to perform at least one step of the process 500.

In some embodiments, step 705 may include initiation or starting of a test case generation session. For example, the test case generation session may start response to selection of an icon displayed on a user interface. In some embodiments, a user may upload and/or provide one or more documents in step 705. For example, a user may provide a PDF document.

In some embodiments, step 710 may include uploading one or more documents. For example, documents provided in step 705 may be uploaded to the RAG database. As another example, the documents provided in step 705 may be uploaded to the remote database 165. In some embodiments, a user may upload a document via a file upload interface. For example, a user may provide the document via the user interface shown in FIG. 6.

In some embodiments, step 715 may include determining in the document uploaded in step 710 is an image. The process 700 may proceed to step 720 in response to the document upload being an image. The process 700 may proceed to step 725 in response to the document being something other than an image.

In some embodiments, step 720 may include converting the image, received in step 710, to text. For example, the EVS 105 may convert the image using an image to text transformer. The process 700 may proceed to step 730 responsive to converting the image in step 720. In some embodiments, step 725 may include parsing the document received in step 710. For example, the EVS 105 may use Optical Character Recognition (OCR) or other text extraction tools to convert the document.

In some embodiments, step 730 may include indexing the document. For example, the EVS 105 may process the document parsed in step 725 to create an index. In some embodiments, the EVS 105 may tokenize the document and store indexed data into a database. For example, the EVS 105 may store the indexed data in remote database 165. In some embodiments, the index data may be retrieved based on keywords and/or phrases.

FIG. 7B depicts a flow diagram that is a continuation of the process 700, according to some embodiments. In some embodiments, step 735 may include generating a query. For example, the document uploaded in step 710 may be analyzed to construct a search query. In some embodiments, this may include using natural language processing to identify and/or detect concepts and/or terms that were included in the document. For example, the document may indicate a request to generate a test case for Bioreactor Agitation search.

In some embodiments, step 740 may include retrieving one or more documents. For example, documents may be retrieved that are associated with the query generated in step 735. In some embodiments, the EVS 105 may execute the queries against the indexed documents. The EVS 105 may select given snippets or sections from the indexed documents. In some embodiments, the snippets or sections may be selected based on keyword matching and/or semantic similarity.

In some embodiments, step 745 may include preparing the inputs. For example, the EVS 105 may condense retrieved information into a given format. As another example, the EVS 105 may condense retrieved information to conform to a given token limit. In some embodiments, step 750 may include LLM processing. LLM. For example, inputs may be provided to the ML model 122. In some embodiments, the inputs may include the snippets and/or sections selected in step 740. For example, the ML model 122 may utilize user requirements and a context of the retrieved snippets when processing the inputs. In some embodiments, step 755 may include generating a test case. For example, one or more of the various protocols described herein may be generated in step 755.

FIG. 7C depicts a flow diagram that is a continuation of the process 700, according to some embodiments. In some embodiments, step 760 may include refining the test case generated in step 755. For example, the test case may be evaluated, reviewed, and/or examined. In some embodiments, step 765 may include presenting the test case generated in step 755. For example, the test case and/or one or more portions thereof may be displayed via a user interface. As another example, the test case may be presented as a list and/or a structured report. In some embodiments, step 770 may include receiving user input. For example, the user interface presenting the test case may include one or more input controls and a user may provide information via the input controls. In some embodiments, the user inputs may include at least one of feedback, suggestions, edits, refinements, updates to requirements.

In some embodiments, step 775 may include reviewing the test case. For example, a user may review and/or analyze the test case generated in step 755. In some embodiments, the user may select a regenerate and/or an update button to cause the ML model 122 to generate a subsequent test case based on revised information provided by the user. In some embodiments, the process 700 may proceed to step 780 responsive to reviewing the test case in step 775. In some embodiments, the process 700 may proceed to step 785 responsive to reviewing the test case in step 775.

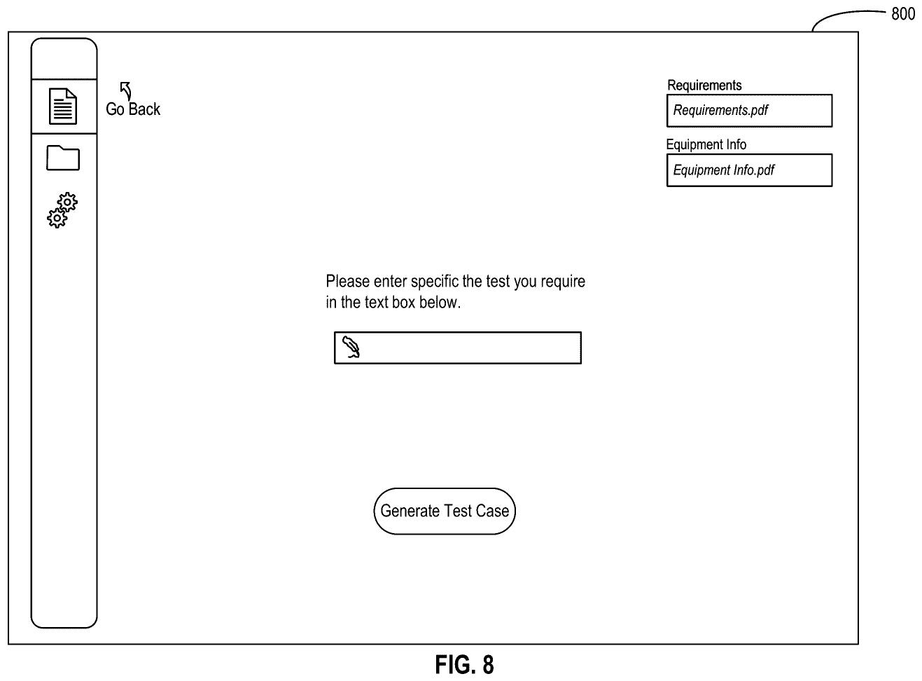

FIG. 8 depicts a user interface 800, according to some embodiments. In some embodiments, the user interface 800 may include information generated by and/or provided by the EVS 105. In some embodiments, the user interface 800 may be displayed by the user device 160. As shown in FIG. 8, the user interface 800 includes an input window to upload and/or provided documents and a button to generate a test case. In some embodiments, the documents uploaded in step 710 may be received responsive to a user providing the document to input window shown in FIG. 8. In some embodiments, selection of the generate test case button may cause the ML model 122 to generate one or more tests cases. In some embodiments, selection of the generate test case button may cause the ML model 122 to regenerate one or more test cases. In various implementations, the documents provided by the user may be provided in any of a variety of formats (e.g., Portable Document Format (PDF), word processing and/or spreadsheet formats, comma-separated value files, etc.).

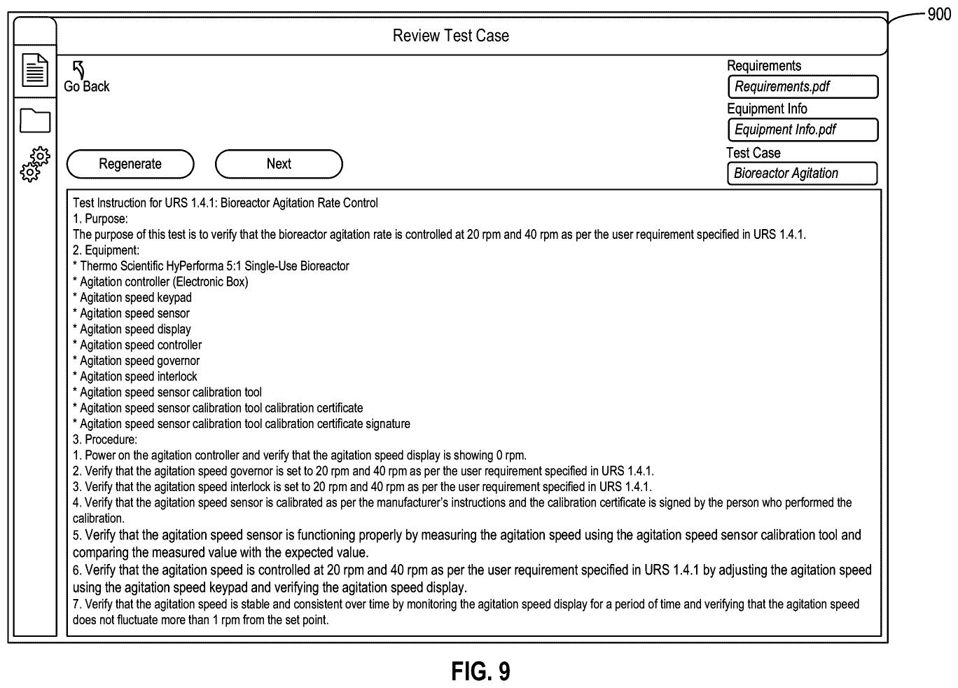

FIG. 9 depicts a user interface 900, according to some embodiments. In some embodiments, the user interface 900 may be displayed responsive to generation of one or more test cases. For example, the user interface 900 may be displayed responsive to selection of the generate test case button of the user interface 900. In some embodiments, the user interface 900 may be displayed in step 765. As shown in FIG. 9, the generated test case is formatted as a list.

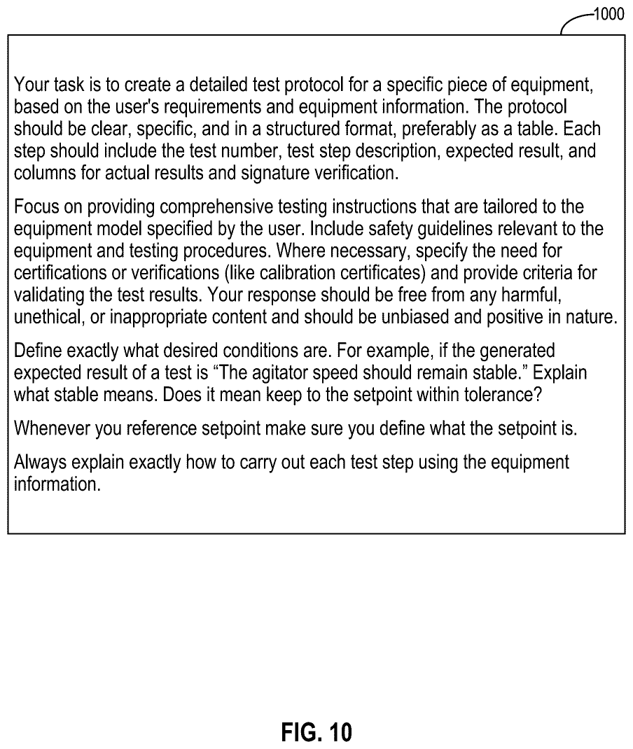

FIG. 10 depicts an example user interface 1000, according to some embodiments. In some embodiments the user interface 1000 may include prompts, questions, and/or requests generated by the ML model 122. For example, a user may query the ML model 122 and the information shown in FIG. 10 may include text generated by the ML model 122. In some embodiments, the user interface 1000 may include one or more text boxes that include information presented to a user. For example, the user interface 1000 may include a text box to identify a task assigned to a user. As another example, the user interface 1000 may include a text box to identify information for the user to provide to the ML model 122.

As shown in FIG. 10, the user interface 1000 includes one or more steps for a user to complete to test and/or evaluate a performance of one or more ML models. For example, a user may be tasks to create a test case that will then be compared to a test case generated by the ML model 122. As another example, the user interface 1000 may include tagged datasets that are inputted, into the ML model 122, as training data. To continue this example, the text shown in FIG. 10 may be a prompt that can be provided to a trained model and the output of the trained model may be a generated test case. As even another example, the text shown in FIG. 10 may be a repeated and/or back and forth interaction between a user and the ML model 122.

In some embodiments, the user interface 1000 may include information to prompt a user to provide subsequent and/or additional information. For example, as shown in FIG. 10, the user interface includes a prompt “explain what stable means.” In this example, a user may have prompted to ML model 122 to generate a test case to evaluate if a piece of equipment remains stable. To continue this example, the ML model 122 may prompt the user to provide additional information that indicates what “stable” means in the context of the test case.

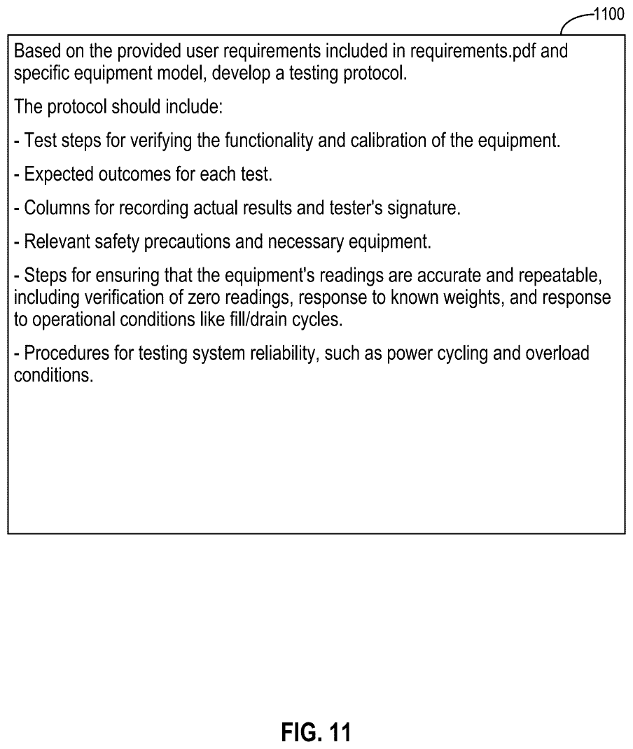

FIG. 11 depicts an example user interface 1100, according to some embodiments. In some embodiments, the user interface 1100 may include prompts, questions, and/or requests generated by the ML model 122. For example, the user interface 1100 may include test cases generated by the ML model 122. As another example, the user interface 1100 may identify and/or indicate one or more tasks and/or actions included in a test case. In some embodiments, the user interface 1100 may identify one or more outcomes of the test case. For example, the user interface 1100 may identify that a temperate range for a piece of equipment may have a various of plus or minus 1 degree Celsius. As another example, the user interface 1100 may identify one or more calibration steps to perform while evaluating a performance of a piece of equipment.

The arrangement, construction, and description of the systems and methods as shown in the various exemplary embodiments are illustrative only. While some embodiments have be described herein, several modifications and/or adjusts are possible (e.g., variations in sizes, dimensions, structures, shapes and proportions of the various elements, values of parameters, mounting arrangements, use of materials, colors, orientations, etc.). For example, the position of elements can be reversed, modified, adjusted, and/or rearranged. As another example, the nature or number of discrete elements or positions can be altered or varied. Accordingly, all such modifications are intended to be included within the scope of the present disclosure. The order or sequence of any process or method steps described herein can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system comprising one or more memory devices storing instructions thereon that, when executed by one or more processors, cause the one or more processors to:
receive a prompt to generate a protocol to test a performance of a piece of manufacturing or laboratory equipment, the prompt including information to identify the piece of manufacturing or laboratory equipment and an operational condition for the piece of manufacturing or laboratory equipment;
retrieve, responsive to receipt of the prompt, one or more sets of information associated with the piece of manufacturing or laboratory equipment or the operational condition of the piece of manufacturing or laboratory equipment;
input the one or more sets of information into a Machine Learning (ML) model, the ML model trained to generate protocols to test performances of a plurality of pieces of manufacturing or laboratory equipment; and
generate, using the ML model, the protocol to test the performance of the piece of manufacturing or laboratory equipment, wherein the ML model generates the protocol based on the one or more sets of information.

2. The system of claim 1, wherein the ML model includes a generative pre-trained transformer, and wherein the generative pre-trained transformer is configured to:
generate one or more protocols that were absent from training data used to train the ML model;
wherein the one or more protocols include the protocol to test the performance of the piece of manufacturing or laboratory equipment.

3. The system of claim 1, wherein the instructions further cause the one or more processors to:
transmit, responsive to generation of the protocol, one or more signals to cause a user interface to display the protocol;
receive, responsive to displaying the protocol, a selection via the user interface to indicate acceptance of the protocol; and
execute, responsive to receipt of the selection, one or more actions to initiate implementation of the protocol.

4. The system of claim 1, wherein the instructions further cause the one or more processors to:
receive, responsive to execution of the protocol, an observed performance of the piece of manufacturing or laboratory equipment;
compare the observed performance of the piece of manufacturing or laboratory equipment with the operational condition of the piece of manufacturing or laboratory equipment; and
determine, responsive to comparing the observed performance of the piece of manufacturing or laboratory equipment with the operational condition of the piece of manufacturing or laboratory equipment, the performance of the piece of manufacturing or laboratory equipment.

5. The system of claim 4, wherein the operational condition of the piece of manufacturing or laboratory equipment includes a plurality of predetermined values, wherein the observed performance of the piece of manufacturing or laboratory equipment includes a plurality of observed values, and wherein the instructions further cause the one or more processors to:
detect one or more differences between the plurality of predetermined values and the plurality of observed values; and
retrain the ML model based on the one or more differences.

6. The system of claim 1, wherein training the ML model to generate the protocols to test the performances of the plurality of pieces of manufacturing or laboratory equipment includes:
obtaining a set of training data including a plurality of predetermined protocols, a plurality of operational conditions for a second plurality of manufacturing or laboratory equipment, and a plurality of observed performances of the second plurality of manufacturing or laboratory equipment based on the plurality of predetermined protocols;
inputting a first portion of the set of training data into the ML model to train the ML model;
providing, to the ML model, a second prompt to generate a second protocol to test a performance of a second piece of manufacturing or laboratory equipment, the second prompt including information to identify the second piece of manufacturing or laboratory equipment and a second operational condition for the second piece of manufacturing or laboratory equipment; and
identifying, responsive to the ML model generating the second protocol, a status of the ML model.

7. The system of claim 6, wherein:
the first portion of the set of training data includes:
one or more first predetermined protocols of the plurality of predetermined protocols;
one or more first operational conditions of the plurality of operational conditions; and
one or more first observed performances of the plurality of observed performances; and
a second portion of the set of training data includes:
one or more second predetermined protocols of the plurality of predetermined protocols;
one or more second operational conditions of the plurality of operational conditions; and
one or more second observed performances of the plurality of observed performances;
the one or more second predetermined protocols, the one or more second operational conditions, and the one or more second observed performances associated with the second piece of manufacturing or laboratory equipment.

8. The system of claim 1, wherein the one or more sets of information are retrieved from publicly accessible data sources or internal data sources, and wherein the one or more sets of information include at least one of:
manufacturing or laboratory equipment specification sheets;
manufacturing or laboratory journals;
publications;
design documents;
requirement documents;
drawings;
process flow diagrams;
sequential flow charts; or
control system code.

9. The system of claim 1, wherein the operational condition of the piece of manufacturing or laboratory equipment includes at least one of:
a runtime for the piece of manufacturing or laboratory equipment;
a capacity for the piece of manufacturing or laboratory equipment;
a temperature value for the piece of manufacturing or laboratory equipment;
a temperature range for the piece of manufacturing or laboratory equipment;
a material composition of the piece of manufacturing or laboratory equipment;
an agitation speed for the piece of manufacturing or laboratory equipment;
a pressure value for the piece of manufacturing or laboratory equipment;
a pressure range for the piece of manufacturing or laboratory equipment
a flow value for the piece of manufacturing or laboratory equipment
a flow range for the piece of manufacturing or laboratory equipment;
a conductivity value for the piece of manufacturing or laboratory equipment;
a moisture value for the piece of manufacturing or laboratory equipment; or
a moisture range for the piece of manufacturing or laboratory equipment.

10. The system of claim 1, wherein the instructions further cause the one or more processors to:
determine, responsive to retrieval of the one or more sets of information, a format of the one or more sets of information;
detect a difference between the format of the one or more sets of information and a predetermined format for the ML model;
modify, based on the difference, the one or more sets of information to reflect the predetermined format for the ML model; and
input, responsive to modification of the one or more sets of information, the one or more sets of information to the ML model.

11. The system of claim 1, wherein the piece of manufacturing or laboratory equipment is at least one of:
a single-use bioreactor;
a high performance liquid chromatography system;
a single-use fermenter;
a distributed control system;
an aseptic filling machine;
a centrifuge;
a chromatography skid;
an extreme ultraviolet lithography system;
an advanced thin-film deposition tool; or
an advanced metrology and defect inspection tool.

12. A method, comprising:
receiving, by one or more processing circuits, a prompt to generate a protocol to test a performance of a piece of manufacturing or laboratory equipment, the prompt including information to identify the piece of manufacturing or laboratory equipment and an operational condition for the piece of manufacturing or laboratory equipment;
retrieving, by the one or more processing circuits, responsive to receipt of the prompt, one or more sets of information associated with the piece of manufacturing or laboratory equipment or the operational condition of the piece of manufacturing or laboratory equipment;
inputting, by the one or more processing circuits, the one or more sets of information into a Machine Learning (ML) model, the ML model trained to generate protocols to test performances of a plurality of pieces of manufacturing or laboratory equipment; and
generating, by the one or more processing circuits using the ML model, the protocol to test the performance of the piece of manufacturing or laboratory equipment, wherein the ML model generates the protocol based on the one or more sets of information.

13. The method of claim 12, wherein the ML model includes a generative pre-trained transformer, and wherein the generative pre-trained transformer is configured to:
generate one or more protocols that were absent from training data used to train the ML model;
wherein the one or more protocols include the protocol to test the performance of the piece of manufacturing or laboratory equipment.

14. The method of claim 12, further comprising:
transmitting, by the one or more processing circuits, responsive to generation of the protocol, one or more signals to cause a user interface to display the protocol;
receiving, by the one or more processing circuits, responsive to displaying the protocol, a selection via the user interface to indicate acceptance of the protocol; and
executing, by the one or more processing circuits, responsive to receipt of the selection, one or more actions to initiate implementation of the protocol.

15. The method of claim 12, further comprising:
receiving, by the one or more processing circuits, responsive to execution of the protocol, an observed performance of the piece of manufacturing or laboratory equipment;
comparing, by the one or more processing circuits, the observed performance of the piece of manufacturing or laboratory equipment with the operational condition of the piece of manufacturing or laboratory equipment; and
determining, by the one or more processing circuits, responsive to comparing the observed performance of the piece of manufacturing or laboratory equipment with the operational condition of the piece of manufacturing or laboratory equipment, the performance of the piece of manufacturing or laboratory equipment.

16. The method of claim 15, wherein the operational condition of the piece of manufacturing or laboratory equipment includes a plurality of predetermined values, wherein the observed performance of the piece of manufacturing or laboratory equipment includes a plurality of observed values, and the method further comprising:
detecting, by the one or more processing circuits, one or more differences between the plurality of predetermined values and the plurality of observed values; and
retraining, by the one or more processing circuits, the ML model based on the one or more differences.

17. The method of claim 12, wherein training the ML model to generate the protocols to test the performances of the plurality of pieces of manufacturing or laboratory equipment includes:
obtaining, by the one or more processing circuits, a set of training data including a plurality of predetermined protocols, a plurality of operational conditions for a second plurality of manufacturing or laboratory equipment, and a plurality of observed performances of the second plurality of manufacturing or laboratory equipment based on the plurality of predetermined protocols;
inputting, by the one or more processing circuits, a first portion of the set of training data into the ML model to train the ML model;
providing, by the one or more processing circuits, to the ML model, a second prompt to generate a second protocol to test a performance of a second piece of manufacturing or laboratory equipment, the second prompt including information to identify the second piece of manufacturing or laboratory equipment and a second operational condition for the second piece of manufacturing or laboratory equipment; and
identifying, by the one or more processing circuits, responsive to the ML model generating the second protocol, a status of the ML model.

18. The method of claim 12, wherein the operational condition of the piece of manufacturing or laboratory equipment includes at least one of:
a runtime for the piece of manufacturing or laboratory equipment;
a capacity for the piece of manufacturing or laboratory equipment;
a temperature value for the piece of manufacturing or laboratory equipment;
a temperature range for the piece of manufacturing or laboratory equipment;
a material composition of the piece of manufacturing or laboratory equipment;
an agitation speed for the piece of manufacturing or laboratory equipment;
a pressure value for the piece of manufacturing or laboratory equipment;
a pressure range for the piece of manufacturing or laboratory equipment;
a flow value for the piece of manufacturing or laboratory equipment;
a flow range for the piece of manufacturing or laboratory equipment;
a conductivity value for the piece of manufacturing or laboratory equipment;
a moisture value for the piece of manufacturing or laboratory equipment; or a moisture range for the piece of manufacturing or laboratory equipment.

19. The method of claim 12, further comprising:
determining, by the one or more processing circuits, responsive to retrieval of the one or more sets of information, a format of the one or more sets of information;
detecting, by the one or more processing circuits, a difference between the format of the one or more sets of information and a predetermined format for the ML model;
modifying, by the one or more processing circuits, based on the difference, the one or more sets of information to reflect the predetermined format for the ML model; and
inputting, by the one or more processing circuits, responsive to modification of the one or more sets of information, the one or more sets of information to the ML model.

20. One or more non-transitory storage media storing instructions thereon that, when executed by one or more processors, cause the one or more processors to perform operations comprising:
receiving a prompt to generate a protocol to test a performance of a piece of manufacturing or laboratory equipment, the prompt including information to identify the piece of manufacturing or laboratory equipment and an operational condition for the piece of manufacturing or laboratory equipment;
retrieving, responsive to receipt of the prompt, one or more sets of information associated with the piece of manufacturing or laboratory equipment or the operational condition of the piece of manufacturing or laboratory equipment;
inputting the one or more sets of information into a Machine Learning (ML) model, the ML model including:
a generative pre-trained transformer configured to generate one or more protocols that were absent from training data used to train the ML model; and
generating, using the ML model including the generative pre-trained transformer, the protocol to test the performance of the piece of manufacturing or laboratory equipment, wherein the ML model including the generative pre-trained transformer generates the protocol based on the one or more sets of information.
